(19) United States
(12) Patent Application Publication
(10) Pub. No.: US 2025/0189784 A1
(43) Pub. Date: Jun. 12, 2025

(54) FOLDED OPTICAL SYSTEM OPTIMIZED TO MITIGATE GLARE

(71) Applicant: 3M INNOVATIVE PROPERTIES COMPANY, St. Paul, MN (US)

(72) Inventors: Jincy Jose, Eagan, MN (US); Craig R. Schardt, Woodbury, MN (US); Byoung Kyu Kim, Hwaseong-si (KR)

(21) Appl. No.: 18/685,988

(22) PCT Filed: Aug. 23, 2022
(86) PCT No.: PCT/IB2022/057891

§ 371 Date: Feb. 23, 2024

Related U.S. Application Data
(60) Provisional application No. 63/238,384, filed on Aug. 30, 2021.

(51) Int. Cl. G02B 27/01; G02B 13/00; G02B 27/28

(52) U.S. Cl. CPC G02B 27/0101; G02B 13/0065; G02B 27/283; G02B 2207/123

(57) ABSTRACT

An optical system includes an imager, a reflective polarizer, a primary mirror, and a glare trap. The optical system is configured to display a virtual image of an image emitted by the imager after the emitted image is reflected by the primary mirror and transmitted by the reflective polarizer and exits the system through the glare trap. For every light ray emitted by the imager and which exits the system through the glare trap along a first direction, when a light ray is incident on the glare trap along a second direction coincident with and opposite to the first direction, the glare trap transmits at least some of the incident light ray, such that if the transmitted incident light ray attempts to exit the optical system through the glare trap, the glare trap traps the transmitted incident light, transmitting no more than about 2% of the transmitted incident light ray.

### SUMMARY

In some aspects of the present description, an optical system is provided, the optical system including an imager, a reflective polarizer, a primary mirror, and a glare trap. The optical system is configured to display a virtual image of an image emitted by the imager to a viewer after the emitted image is reflected by the primary mirror and transmitted by the reflective polarizer and exits the optical system through the glare trap. For every light ray that is emitted by the imager and which exits the optical system through the glare trap along a first direction for viewing by the viewer, when a light ray is incident on the glare trap along a second direction coincident with and opposite the first direction, the glare trap transmits at least some of the incident light ray, such that if the transmitted incident light ray attempts to exit the optical system through the glare trap, the glare trap traps the transmitted incident light and transmits no more than about 2% of the transmitted incident light ray.

In some aspects of the present description, an optical system is provided, the optical system configured to display a virtual image of an image emitted by an imager to a viewer. The optical system includes the imager, a primary mirror, a louver, and an exit surface disposed along a folded optical path. Light rays that are emitted by the imager follow the folded optical path and exit the optical system through the exit surface along corresponding forward directions toward the viewer are substantially transmitted by the louver, while light rays incident on the exit surface along reverse directions coincident with and opposite to the forward directions are substantially blocked by the louver.

In some aspects of the present description, an optical system is provided, the optical system including an imager, a reflective polarizer, a primary mirror, and a glare trap. The glare trap includes a first side facing the reflective polarizer and an opposing second side. The optical system is configured to display a virtual image of an image emitted by the imager to a viewer after the emitted image is reflected at least once each by the reflective polarizer and the primary mirror, is transmitted by the reflective polarizer, and exits the optical system through the glare trap within a predetermined cone angle relative to an optical axis of the optical system. The primary mirror is disposed relative to the glare trap such that when an incident light ray that is incident on the glare trap from the second side of the glare trap and within the predetermined cone angle, is transmitted by the glare trap and reflected from the primary mirror as a reflected light ray, then the reflected light ray is not transmitted by the glare trap.

In some aspects of the present description, an optical system is provided, the optical system including a reflective polarizer disposed between a glare trap and a display. The optical system is configured to emit a plurality of image rays emitted from the display through the glare trap at a plurality of corresponding image angles, such that any light ray that is incident on the optical system at the glare trap at an incident angle that is substantially equal to one of the image angles, is transmitted by the glare trap and trapped by the optical system.

### BRIEF DESCRIPTION OF THE DRAWINGS

FIGS. 1A and 1B show an optical system with a folded optical path in the prior art which suffers from external light reflected by the system to create optical glare;

FIGS. 2A and 2B show the measured performance in an optical system without sunlight glare and with sunlight glare, in accordance with an embodiment of the present description;

FIG. 3 is a side view of an optical system designed to mitigate glare caused by reflection from within the optical system, in accordance with an embodiment of the present description; and

FIGS. 4A and 4B provide details on a louver used as a glare trap in an optical system, in accordance with an embodiment of the present description;

FIG. 5 is a view of an optical system showing angular positions of an optical system, in accordance with an embodiment of the present description;

FIGS. 6A and 6B show an eye of a viewer moving with an eye box of an optical system, in accordance with an embodiment of the present description; and

FIG. 7 shows additional details on the folded optical path of an optical system, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

With increasing demand for augmented reality Heads Up Display (HUD) systems in automotive markets, the physical volume of HUD systems has increased to meet the demands for such optical systems. To decrease the volumes needed, optical systems were introduced in which the optical path was folded using light polarization and reflective/refractive elements. While the volumes were reduced using these systems, the folded nature of the optical path often meant that sunlight entering the optical system was reflected from elements internal to the system (e.g., the primary HUD mirror) and produced detrimental glare and reflections in the system. Sunlight focused on to the windshield in such systems is estimated to be of the order of 10⁵ Nits, which is an order of magnitude higher than the typical luminance of a HUD virtual image during daylight conditions. In addition, in many cases, the sunlight reflection path overlaps with the HUD optical path, which makes it practically impossible to block the glare without blocking the image being projected for viewing by the driver.

According to some aspects of the present description, an optical system is configured to mitigate glare caused by the reflection of sunlight and other external light sources. In some embodiments, an optical system (e.g., a heads-up display, or HUD) includes an imager (e.g., a picture generating unit, a display, etc.), a reflective polarizer, a primary mirror, and a glare trap. In some embodiments, the optical system may be configured to display a virtual image of an image emitted by the imager to a viewer after the emitted image is reflected by the primary mirror (e.g., a primary HUD mirror) and transmitted by the reflective polarizer and exits the optical system through the glare trap. In some embodiments, for every light ray that is emitted by the imager and which exits the optical system through the glare trap along a first direction for viewing by the viewer (e.g., a direction leading from the glare trap to a windshield, where the image is reflected for viewing), when a light ray (e.g., an incoming solar ray) is incident on the glare trap along a second direction coincident with and opposite the first direction, the glare trap may transmit at least some of the incident light ray (i.e., allow some of the ray to enter the optical system), such that if the transmitted incident light ray attempts to exit the optical system through the glare trap, the glare trap traps (e.g., blocks) the transmitted incident light and transmits no more than about 2%, or no more than about 1%, or no more than about 0.1% of the transmitted incident light ray.

In some embodiments, the glare trap may include a plurality of spaced-apart, substantially parallel slats extending along a first glare trap direction (e.g., along an x-axis of the glare trap) and arranged along a different, second glare trap direction (e.g., a direction orthogonal to the first glare trap direction, such as a y-axis of the glare trap.) In some embodiments, the glare trap may include an acceptance cone defined by a maximum angle of incidence, θ_{c}, of a light ray substantially transmitted by the glare trap. That is, the glare trap may be configured such that incident light rays that are incident at an angle less than or equal to θ_{c} will be substantially transmitted by the glare trap, and light rays incident on the glare trap at an angle greater than θ_{c} will be substantially blocked by the glare trap. In some embodiments, the primary mirror may be disposed at an angle relative to the glare trap such that light rays transmitted by the glare trap along the second direction are reflected from the primary mirror at an angle outside of the acceptance cone of the glare trap. In some embodiments, the light rays transmitted by the glare trap (i.e., entering the optical system through the glare trap) and reflected from the primary mirror may have an angle of incidence on the glare trap, θₘ, that is greater than or equal to ½θ_{c}.

In some embodiments, the optical system may further include an eye-box defining possible positions of an eye of the viewer, such that the transmitted incident light is trapped by the glare trap for any position of the eye within the eye-box.

According to some aspects of the present description, an optical system may be configured to display a virtual image of an image emitted by an imager to a viewer. In some embodiments, the optical system may include the imager, a primary mirror, a louver, and an exit surface (e.g., the surface of the optical system through which image light exits the system, which may be a surface of the louver, in some embodiments) disposed along a folded optical path. For the purposes of this discussion, an optical path may be defined as an optical path for an optical system which has been folded through the use of reflective elements (e.g., mirrors), refractive elements (e.g., lenses), and/or polarization-dependent optical elements (e.g., multilayer optical film polarizers, optical retarder plates, etc.) such that the length of the optical path is longer than the physical length of the optical system. In some embodiments, for example, at least two different, adjacent segments of the folded optical path may make an angle of less than about 45 degrees, or less than about 40 degrees, or less than about 35 degrees, with each other.

In some embodiments, light rays that are emitted by the imager may follow the folded optical path and exit the optical system through the exit surface along corresponding forward directions toward the viewer may be substantially transmitted by the louver, while light rays incident on the exit surface along reverse directions coincident with and opposite to the forward directions (e.g., sunlight rays entering the optical system) are substantially blocked by the louver, or trapped by the louver, when exiting the optical system.

In some embodiments, the louver may include a plurality of spaced-apart, substantially parallel slats extending along a first louver direction (e.g., an x-axis of the louver) and arranged along a different second louver direction (e.g., a y-axis of the louver). In some embodiments, the louver may include an acceptance cone defined by a maximum angle of incidence, θ_{c}, of a light ray substantially transmitted by the louver. In some embodiments, the primary mirror may be disposed at an angle relative to the louver such that light rays transmitted by the louver along the reverse directions are reflected from the primary mirror at an angle outside of the acceptance cone of the louver (i.e., they are substantially blocked by the louver and do not leave the optical system). In some embodiments, the light rays transmitted by the louver and reflected from the primary mirror may have an angle of incidence on the louver, θₘ, that is greater than or equal to ½θ_{c} (i.e., outside the acceptance code of the louver).

In some embodiments, the optical system may further include an eye-box defining possible positions of an eye of the viewer. In some embodiments, light rays incident on the exit surface along the reverse directions may be substantially blocked by the louver for any position of the eye within the eye-box.

According to some aspects of the present description, an optical system may include an imager, a reflective polarizer, a primary mirror, and a glare trap. In some embodiments, the glare trap may include a first side facing the reflective polarizer and an opposing second side. In some embodiments, the optical system may be configured to display a virtual image of an image emitted by the imager to a viewer after the emitted image is reflected at least once each by the reflective polarizer and the primary mirror, is transmitted by the reflective polarizer, and exits the optical system through the glare trap within a predetermined cone angle relative to an optical axis of the optical system. In some embodiments, the primary mirror may be disposed relative to the glare trap such that when an incident light ray that is incident on the glare trap from the second side of the glare trap (i.e., from a point external to the optical system) and within the predetermined cone angle, is transmitted by the glare trap (i.e., enters the optical system) and is reflected from the primary mirror as a reflected light ray, then the reflected light ray is not transmitted by the glare trap (e.g., is trapped or blocked by the glare trap).

In some embodiments, the glare trap includes an acceptance cone defined by a maximum angle of incidence, θ_{c}, of a light ray substantially transmitted by the glare trap. In some embodiments, the intensity of the transmitted light ray may be at least 80% of the intensity of the incident light ray. In some embodiments, the primary mirror may be disposed at an angle relative to the glare trap such that the reflected light ray is incident on the glare trap at an angle outside of the acceptance cone of the glare trap (i.e., the reflected light ray is substantially blocked or trapped by the glare trap). In some embodiments, the reflected light ray may be incident on the glare trap at an angle, θₘ, that is greater than or equal to ½θ_{c} (i.e., it is outside the acceptance cone of the glare trap and therefore substantially blocked by the glare trap).

In some embodiments, the optical system may further include an eye-box defining possible positions of an eye of the viewer, wherein the reflected light ray is not transmitted by the glare trap for any position of the eye within the eye-box.

According to some aspects of the present description, an optical system may include a reflective polarizer disposed between a glare trap and a display. In some embodiments, the optical system may be configured to emit a plurality of image rays emitted from the display through the glare trap at a plurality of corresponding image angles, such that any light ray that is incident on the optical system at the glare trap at an incident angle that is substantially equal to one of the image angles, is transmitted by the glare trap and trapped by the optical system.

In some embodiments, the glare trap may be or include a louver. For example, in some embodiments, the glare trap may include a plurality of spaced-apart, substantially parallel slats extending along a first glare trap direction (i.e., a first dimension of the glare trap, such as a length) and arranged along a different second glare trap direction (i.e., a second dimension of the glare trap, such as a width).

In some embodiments, the optical system may further include a primary mirror. In some embodiments, the display, the primary mirror, the reflective polarizer, and the glare trap define a folded optical path of the optical system. That is, a light ray emitted by the display will impinge on, be reflected by, or be transmitted by each of the primary mirror, the reflective polarizer, and the glare trap at least once. In some embodiments, the primary mirror may be disposed at an angle relative to a plane of the glare trap such that the light ray incident on the optical system at the glare trap and transmitted by the glare trap is reflected by the primary mirror such that it is trapped by the glare trap.

In some embodiments, the glare trap may include a plurality of spaced-apart, substantially parallel slats extending along a first glare trap direction and arranged along a different second glare trap direction (e.g., the glare trap may be a louver). In some embodiments, a geometry of the slats in the glare trap may define an acceptance cone defined by a maximum angle of incidence, θ_{c}. In some embodiments, the angle of reflection of the light ray reflected by the primary mirror may be outside the acceptance cone (and therefore substantially blocked by the glare trap).

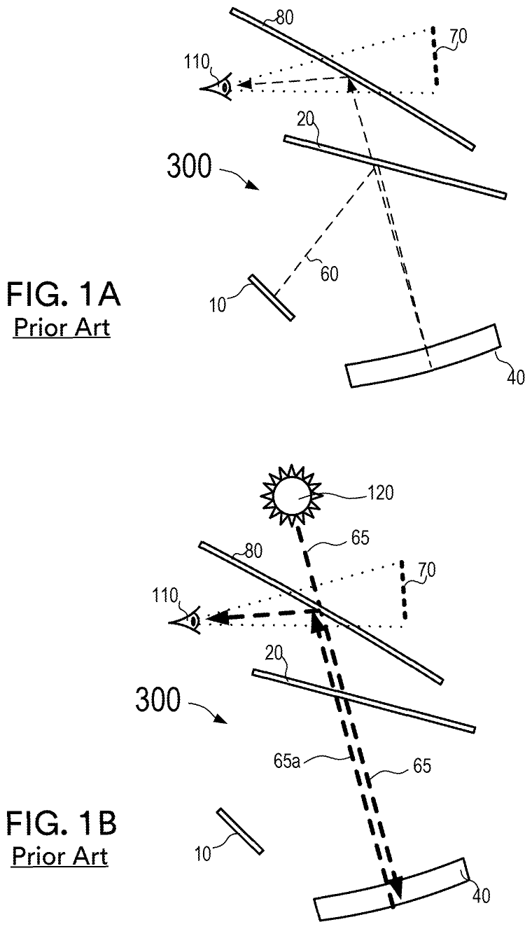

Turning now to the figures, FIGS. 1A and 1B show an optical system with a folded optical path in the prior art which suffers from external light reflected by the system to create optical glare. In FIG. 1A, a prior art optical system 300, such as a heads-up display (HUD), may include a picture-generating unit 10 (e.g., a display), which emits one or more image rays 60. Image rays 60 may be a first polarization of light (e.g., linear s-pol or linear p-pol) that is reflected by reflective polarizer 20. The reflected image rays 60 are directed to a primary HUD mirror 40, where they are reflected. The optical system 300 may include one or more films or elements which switch or rotate the polarization type of image rays 60 (e.g., from linear s-pol light to linear p-pol light, or vice versa), so that image rays 60 then pass through reflective polarizer 20, where they impinge on a surface, such as windshield 80, and are then reflected toward the eye of a viewer 110, who perceives a virtual image 70 at some point beyond windshield 80.

The elements of the display 10, the reflective polarizer 20, and the HUD mirror 40 define a folded optical path, wherein the polarization of the image rays 60 is manipulated to control the reflection from or transmission through the reflective polarizer 20. This folded optical path using a single mirror allows for the creation of a sufficiently long focal length to achieve the desired virtual image 70 in a significantly more compact space than other HUD systems (e.g., up to 40% less internal volume that other HUD configurations using two mirrors to define the folded optical path.) However, as can be seen in FIG. 1B, this arrangement of HUD components allows incoming sunlight rays 65 from the sun 120 to pass through windshield 80 and reflective polarizer 20, be reflected from HUD mirror 40, and return, following the optical path of image rays 60 and impinge on the windshield 80 to create a bright glare spot within the boundaries of the virtual image 70. This glare spot may be on the order of 10⁵ nits, which is at least an order of magnitude greater than the typical luminance of HUD virtual image 70. The sunlight reflection path (shown by sunlight ray 65 in FIG. 1B) can overlap with the HUD's image optical path (shown by image ray 60 in FIG. 1A), making it impossible to block without also blocking the image itself. It should be noted that, although optical system 300 shown in FIGS. 1A and 1B uses a single mirror (HUD mirror 40), this sunlight glare problem exists in optical systems with other arrangements, including two-mirror systems, when the position of the HUD mirror (that is, a plane through the mirror) is substantially orthogonal to the image's optical path in the system. In such systems, the image rays 60 emitted by display 10 may first be reflected by a “fold mirror” before being reflected by the reflective polarizer 20 and the HUD mirror 40, and then transmitted by the reflective polarizer 20 onto the windshield 80. In such systems in the art, the position of the HUD mirror is often such that it allows sunlight rays to follow the system's optical path in the reverse direction, creating the glare on the windshield similar to that shown in FIG. 1B.

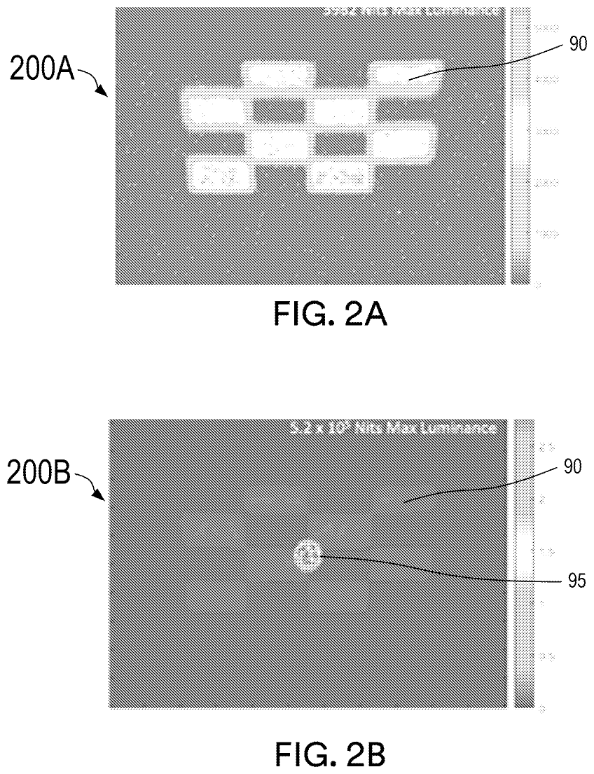

To illustrate the problem of sunlight glare, FIGS. 2A and 2B show the measured performance in an optical system without sunlight glare (FIG. 2A) and with sunlight glare (FIG. 2B). Looking first at FIG. 2A, we see a luminance measurement 200A showing an image 90 (in this example, the image is a simple checkerboard pattern). Image 90 has a maximum luminance measurement of 3982 nits. FIG. 2B shows a similar luminance measurement 200B when sunlight glare 95 is seen in or near the image 90. In the example of FIG. 2B, the maximum luminance measurement is now 5.2-10⁵ nits (the brightness measured for the spot of sunlight glare 95) and the image 90 is much harder to see in comparison. That is, the sunlight glare 95 is approximately 130 times brighter than the brightest spot in image 90.

In some cases, a glare trap may be added to a HUD system to mitigate some of the sunlight glare occurring at certain angles of incidence. For example. A louver with a series of parallel slats may define an “acceptance cone” that will only allow light rays with an angle of incidence below a threshold (the threshold defined by the geometry of the louver) to be transmitted through the louver. While this may eliminate sunlight from entering into the HUD at larger angles of incidence, sunlight rays that happen to be aligned with the optical image path of the HUD will still be substantially transmitted by the louver. That is, sunlight rays which are incident on the louver along a direction coincident with (but opposite to) the direction of the emitted image rays leaving the HUD system will still be allowed to pass through, as they are within the acceptance cone defined by the louver. These rays may follow the optical path of the system, be reflected by the HUD mirror, and return through the louver to become glare obscuring the virtual image, as shown in FIG. 2B.

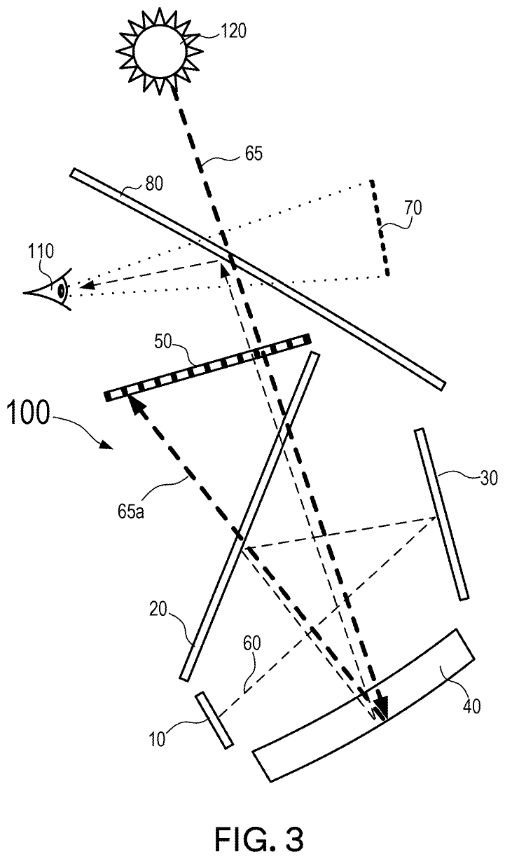

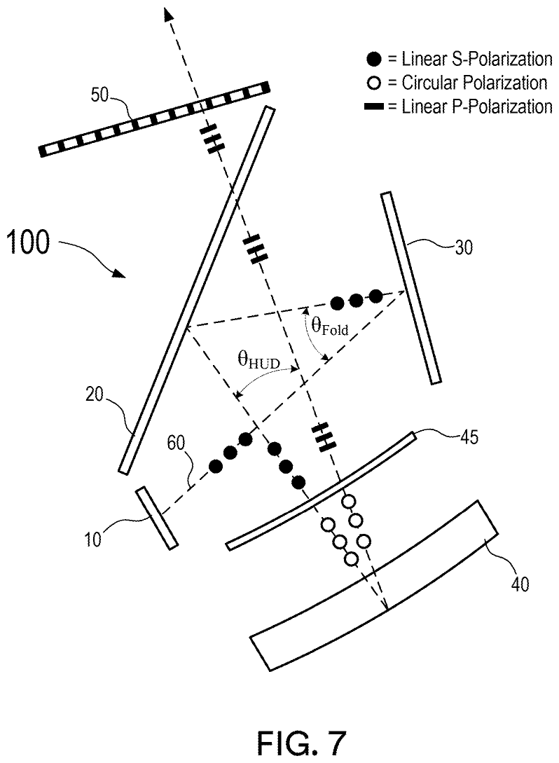

FIG. 3 shows a side view of an optical system designed to mitigate glare caused by reflection from within the optical system, according to the present description. In some embodiments, optical system 100 may include a picture-generating unit 10 (e.g., a display) emitting one or more image rays 60. In some embodiments, image rays 60 may first be reflected from a first mirror (e.g., a “fold” mirror) 30, before being reflected from a reflective polarizer 20. In some embodiments, reflective polarizer 20 may substantially reflect light having a first polarization type (e.g., light with a linear s-pol polarization type) and may substantially transmit light having a second, orthogonal polarization type (e.g., light with a linear p-pol polarization type). Image rays 60 initially have the first polarization type and are reflected from reflective polarizer 20 toward HUD mirror 40. After being reflected from HUD mirror 40, the image rays 60 now are of the second polarization type and are substantially transmitted through reflective polarizer 20. In some embodiments, optical system 100 may further include one or more optical elements (e.g., a multilayer optical film or other optical layer) such as a quarter wave plate which may alter the polarization type of the image rays 60. Although these polarization-altering elements are omitted from FIG. 3, an example of such a polarization-altering embodiment is shown in FIG. 7 and discussed elsewhere herein. Image rays 60, now of the opposite, second polarization type, are transmitted by reflective polarizer 20, are substantially transmitted through a glare trap 50, and impinge on windshield 80 (or a similar surface) where they are reflected into the eye of a viewer 110 to create virtual image 70.

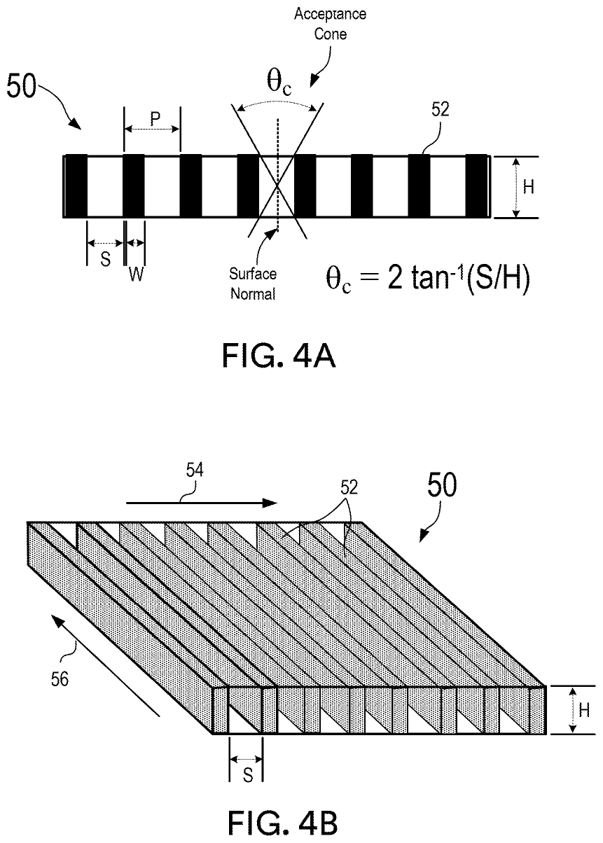

In some embodiments, light rays 65 from the sun 120 (or similar external light source) may pass through windshield 80 following a path that is coincident with, but opposite to, the optical path of the system (i.e., the path followed by image rays 60). Light rays 65 following such a path may be transmitted through louver 50, through reflective polarizer 20, and be reflected by HUD mirror 40. In the embodiment of FIG. 3, the HUD mirror 40 is arranged at an angle relative to at least the glare trap 50 such that sunlight rays 65 are reflected from HUD mirror 40 at an angle that is outside the acceptance cone of the glare trap 50. That is, sunlight rays 65 are reflected from HUD mirror 40 at such an angle that they will be blocked or “trapped” from exiting the glare trap 50, and thus will not be projected onto the windshield 80 and will not obscure the virtual image 70 thus formed. In some embodiments, glare trap 50 may trap the incident light rays 65 such that no more than about 2%, or no more than about 1%, or preferably no more than about 0.1% of light rays 65 is transmitted by glare trap 50. Additional detail regarding the glare trap 50 and its acceptance cone are discussed elsewhere herein and in FIGS. 4A and 4B.

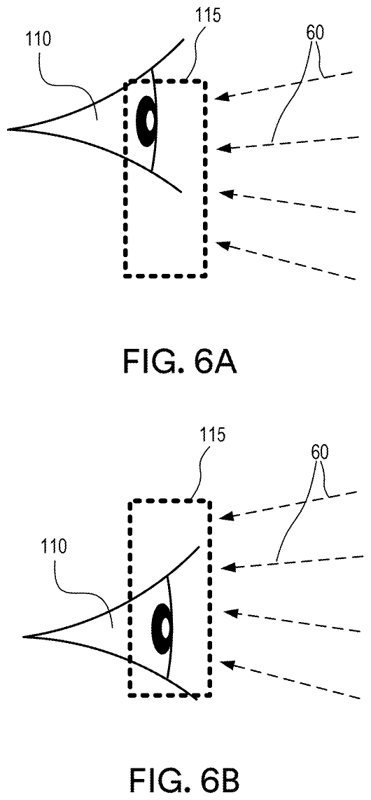

In some embodiments, optical system 100 may further include an “eye box”, or a three-dimensional volume of space defining possible positions of the eye 110 for which image light rays 60 are visible and substantially in focus (i.e., positions for which the virtual image 70 is well defined and substantially clear and discernible) and for which any reflected sunlight rays 65 are still blocked or trapped by glare trap 50. Additional details on such an eye box are given in FIGS. 6A and 6B and discussed elsewhere herein.

It should be noted that careful arrangement of the optical components within optical system 100, including the position and orientation of the display 10, fold mirror 30, reflective polarizer 20, HUD mirror 40, and glare trap 50 allow for a folded optical path which allows image rays 60 to exit through the glare trap 50 along a first direction to create virtual image 70, but which traps sunlight rays 65 which follow a second direction (opposite to and coincident with the first direction) as they enter into the HUD system. Of particular note are the relationships between the angles of orientation of the glare trap 50 and the HUD mirror 40.

FIGS. 4A and 4B provide details on glare trap 50 of FIG. 3 in the embodiment of optical system 100. Examining FIGS. 4A and 4B simultaneously, glare trap 50 may include a plurality of spaced-apart, substantially parallel slats 52 extending along a first glare trap direction 56 and arranged along a different second glare trap direction 54. In some embodiments, the glare trap 50 may include an acceptance cone defined by a maximum angle of incidence, θc, where the acceptance code represents the angles of incidence of a light ray which will be substantially transmitted by glare trap 50 (i.e., allowed to pass through glare trap 50). The angle, θc, may be defined by the equation:

$$θ c = 2 {tan}^{- 1} ( S / H )$$

where S is the dimension representing the spacing between successive slats 52 and H represents the height of the glare trap 50. Other dimensions defining the glare trap 50, but not necessarily or directly contributing to the definition of θc include P (the “period” or the distance between the start of one slat 52 and the start of the adjacent slat 52) and W (the width of an individual slat 52).

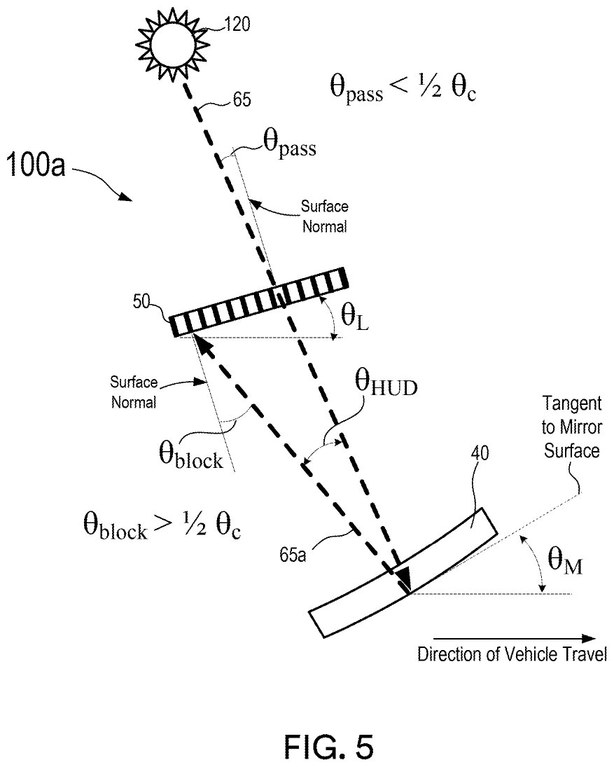

FIG. 5 is a view of an optical system showing angular positions of an optical system, according to the present description. It should be noted that optical system 100a is not a complete system and only shows the relationship between the primary HUD mirror 40 and the glare trap 50, and how they may pass or block a light ray 65 from the sun 120 (or other external light source). Other components necessary for a function HUD system (such as those shown in FIG. 3) are omitted for clarity. In the embodiment of optical system 100a shown in FIG. 5, the primary HUD mirror 40 may be disposed at an angle relative to the glare trap such that light rays transmitted by the glare trap along the second direction are reflected from the primary mirror at an angle outside of the acceptance cone of the glare trap.

For example, a light ray 65 which is incident on the glare trap with an angle of incidence which is less than ½θc (e.g., angle θₚₐₛₛ, shown in FIG. 5) will be transmitted through glare trap 50 and will impinge on HUD mirror 40. Light ray 65 is then reflected from HUD mirror 40 at angle θ_{HUD}, which is the angle between the incoming light ray and the light ray reflected from the HUD mirror 40. If this reflected light ray 65 impinges on the glare trap 50 at an angle which is greater than ½θc (e.g., angle θ_{block}, shown in FIG. 5), the reflected light ray 65 will be substantially trapped (blocked) by the glare trap and will not be transmitted therethrough. To achieve such an embodiments, the optical system 100a may be configured such that the angle of the glare trap 50 and the HUD mirror 40 relative to the direction of vehicle travel (θ_{L} and θ_{M}, respectively) produce the desired angular relationship between glare trap 50 and HUD mirror 40. For example, in one embodiment, values of about 23 degrees for θ_{L} and about 39.8 degrees for θ_{M} were shown to be optical tilt angles to prevent incoming sunlight angles from overlapping with the system optical image path while minimizing the overall HUD volume. These specific values for the angles θ_{L} and θ_{M} are only one example and are not meant to be limiting in any way. Other angles and configurations exist which are within the spirit of the present description.

FIGS. 6A and 6B show an eye of a viewer moving with an eye box of an optical system, as previously discussed elsewhere herein. In some embodiments, an eye box 115 is defined as a three-dimensional volume of space throughout which an eye 110 of a viewer may move and still be able to receive and view image rays 60 without significant changes in focus or image resolution. FIG. 6A shows eye 110 in an upper portion of eye box 115, where it may receive image rays 60 entering the upper portion of eye box 115. FIG. 6B shows eye 110 in a lower portion of eye box 115, where it may receive image rays 60 entering the lower portion of eye box 115. In some embodiments, the optical system (such as optical system 100 of FIG. 3) is configured such that the external light rays (e.g., incoming sunlight rays) 65 are trapped by the glare trap, no matter which part of the eye box 115 the eye 110 of the viewer is located in. That is, the performance of the optical system described herein shall be such that it does not change significantly depending on the position of the eye 110 in the eye box 115 designed for the system.

Finally, FIG. 7 shows additional details on the folded optical path of an optical system 100 of FIG. 3, including elements to rotate or change the polarization type of image rays passing through the system. The image rays shown in FIG. 3 are indicated with symbols indicating the polarization types of the rays as they pass through the optical system, indicating changes. It should be noted that the specific polarization scheme shown in FIG. 7 is an example only, and other schemes may be used and are consistent with the present description.

In the embodiment of optical system 100 of FIG. 7, display 10 emits one or more image rays 60, which initially (in this example) have a linear s-pol polarization type. Image rays 60 are reflected first from a fold mirror 30 (maintaining their polarization type) and are reflected from a surface of the reflective polarizer 20 (which, in this example, substantially reflects light of a linear s-pol polarization type). Image rays 60 then pass through a quarter wave plate 45, which changes the polarization type to circular polarization type (or a first “handed-ness” type). These circularly polarized image rays 60 are then reflected by HUD mirror 40 and are reflected as light still of a circular polarization type (but of the reverse “handed-ness” type). The image rays 60 then pass back through quarter wave plate 45 which converts the polarization type to a linear p-pol light, which is substantially transmitted through reflective polarizer 20 and glare trap 50 for display to a viewer. It should be noted that other embodiments of optical system 100 may use additional quarter wave plates 45 in different locations within the system, or other polarization components (e.g., a half wave plate) to achieve a similarly folded optical path. In some embodiments, the angle between two adjacent segments of the folded optical path (such as the angle θ_{FOLD} and θ_{HUD}) may make an angle of less than about 45 degrees with each other.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical system comprising an imager, a reflective polarizer, a primary mirror, and a glare trap, the optical system configured to display a virtual image of an image emitted by the imager to a viewer after the emitted image is reflected by the primary mirror and transmitted by the reflective polarizer and exits the optical system through the glare trap, wherein for every light ray that is emitted by the imager and exits the optical system through the glare trap along a first direction for viewing by the viewer, when a light ray is incident on the glare trap along a second direction coincident with and opposite to the first direction, the glare trap transmits at least some of the incident light ray, such that if the transmitted incident light ray attempts to exit the optical system through the glare trap, the glare trap traps the transmitted incident light and transmits no more than about 2% of the transmitted incident light ray.

2. The optical system of claim 1, wherein the glare trap transmits no more than about 1% of the transmitted incident light ray.

3. The optical system of claim 1, wherein the glare trap transmits no more than about 0.1% of the transmitted incident light ray.

4. The optical system of claim 1, wherein the glare trap comprises a plurality of spaced-apart, substantially parallel slats extending along a first glare trap direction and arranged along a different second glare trap direction.

5. The optical system of claim 1, further comprising an eye-box defining possible positions of an eye of the viewer, wherein the transmitted incident light is trapped by the glare trap for any position of the eye within the eye-box.

6. The optical system of claim 1, wherein the glare trap comprises an acceptance cone defined by a maximum angle of incidence, θ_{c}, of a light ray substantially transmitted by the glare trap, and the primary mirror is disposed at an angle relative to the glare trap such that light rays transmitted by the glare trap along the second direction are reflected from the primary mirror at an angle outside of the acceptance cone of the glare trap.

7. The optical system of claim 6, wherein the light rays transmitted by the glare trap and reflected from the primary mirror have an angle of incidence on the glare trap, θₘ, that is greater than or equal to ½θ_{c}.

8. An optical system configured to display a virtual image of an image emitted by an imager to a viewer, the optical system comprising the imager, a primary mirror, a louver, and an exit surface disposed along a folded optical path, wherein light rays that are emitted by the imager, follow the folded optical path, and exit the optical system through the exit surface along corresponding forward directions toward the viewer, are substantially transmitted by the louver, while light rays incident on the exit surface along reverse directions coincident with and opposite to the forward directions are substantially blocked by the louver.

9. The optical system of claim 8, wherein at least two different, adjacent segments of the folded optical path make an angle of less than about 45 degrees with each other.

10. The optical system of claim 8, wherein the louver comprises a plurality of spaced-apart, substantially parallel slats extending along a first louver direction and arranged along a different second louver direction.

11. The optical system of claim 8, further comprising an eye-box defining possible positions of an eye of the viewer, wherein the light rays incident on the exit surface along the reverse directions are substantially blocked by the louver for any position of the eye within the eye-box.

12. The optical system of claim 8, wherein the louver comprises an acceptance cone defined by a maximum angle of incidence, θ_{c}, of a light ray substantially transmitted by the louver, and the primary mirror is disposed at an angle relative to the louver such that light rays transmitted by the louver along the reverse directions are reflected from the primary mirror at an angle outside of the acceptance cone of the louver.

13. The optical system of claim 12, wherein the light rays transmitted by the louver and reflected from the primary mirror have an angle of incidence on the louver, θₘ, that is greater than or equal to ½θ_{c}.

14. An optical system comprising an imager, a reflective polarizer, a primary mirror, and a glare trap, the glare trap comprising a first side facing the reflective polarizer and an opposing second side, the optical system configured to display a virtual image of an image emitted by the imager to a viewer after the emitted image is reflected at least once each by the reflective polarizer and the primary mirror, is transmitted by the reflective polarizer, and exits the optical system through the glare trap within a predetermined cone angle relative to an optical axis of the optical system, wherein the primary mirror is disposed relative to the glare trap such that when an incident light ray that is incident on the glare trap from the second side of the glare trap and within the predetermined cone angle, transmitted by the glare trap, and reflected from the primary mirror as a reflected light ray, then the reflected light ray is not transmitted by the glare trap.

15. The optical system of claim 14, further comprising an eye-box defining possible positions of an eye of the viewer, wherein the reflected light ray is not transmitted by the glare trap for any position of the eye within the eye-box.

16. The optical system of claim 14, wherein the glare trap comprises an acceptance cone defined by a maximum angle of incidence, θ_{c}, of a light ray substantially transmitted by the glare trap, and the primary mirror is disposed at an angle relative to the glare trap such that the reflected light ray is incident on the glare trap at an angle outside of the acceptance cone of the glare trap.

17. The optical system of claim 16, wherein the reflected light ray is incident on the glare trap at an angle, θₘ, that is greater than or equal to ½θ_{c}.

18.-23. (canceled)
